(19) United States
(12) Patent Application Publication
(10) Pub. No.: US 2008/0267439 A1
(43) Pub. Date: Oct. 30, 2008

(54) CONDENSER MICROPHONE

(75) Inventors: Kentaro YONEHARA, Shizuoka-shi (JP); Yoshio IMAHORI, Shizuoka-shi (JP); Yasunori Tsukuda, Shizuoka-shi (JP); Motoaki ITO, Shizuoka-shi (JP)

Correspondence Address: SUGHRUE-265550, 2100 PENNSYLVANIA AVE. NW, WASHINGTON, DC, 20037-3213, US

(73) Assignee: STAR MICRONICS CO., LTD., Shizuoka-shi (JP)

(21) Appl. No.: 11/782,763

(22) Filed: Jul. 25, 2007

(30) Foreign Application Priority Data
Jul. 25, 2006 (JP) 2006202414

(51) Int. Cl. H04R 11/04

(52) U.S. Cl. 381/355

(57) ABSTRACT

A condenser microphone includes: a casing including a sound hole; a vibration film disposed in the casing so as to face the sound hole; a back plate disposed opposed to the vibration film; a spacer disposed between the vibration film and the back plate; and a hold member including a spring member. The back plate has an outer peripheral shape that is smaller than an inner peripheral shape of the casing so as to provide a clearance between an outer peripheral surface of the back plate and an inner peripheral surface of the casing. The back plate is held by the hold member from an opposite side of the vibration fills.

### BACKGROUND OF THE INVENTION

1. Field of the Invention

The present invention relates to a condenser microphone which is used in equipment such as a cell phone, a video camera and a personal computer.

2. Background Art

Conventionally, as a condenser microphone of this type, for example, there is proposed a condenser microphone which is structured as disclosed in JP-A-2002-345092. That is, this conventional condenser microphone is structured such that a circuit board with electronic components mounted thereon, a lower spacer, a back plate having a back electrode, an upper spacer, and a vibration film support frame with a vibration film carried on the lower surface thereof are piled up and fixed sequentially in order starting from the bottom portion of the condenser microphone.

Here, in this type of condenser microphone including the condenser microphone disclosed in JP-A-2002-345092, after the respective composing parts thereof are piled up and assembled in the assembled manner, these composing parts are heated through a reflow furnace and the electronic components are reflow soldered on the circuit board due to the heat of the reflow furnace. However, in the condenser microphones having the conventional structure including the condenser microphone disclosed in the above-mentioned JP-A-2002-345092, since the back plate is fixed to the circuit board and vibration film support frame in the piled-up state, due to the heat in the reflow soldering operation, the spacers, back plate and the like can be warped or distorted because of the difference of the coefficients between the thermal expansion of the respective composing parts, whereby the vibration plate can be curved, the vibration plate can be tensed excessively or cannot be tensed but loosened, and a clearance between the back plate and vibration film, that is, a condenser gap can be varied; and, as a result of this, the sensitivity characteristic of the condenser microphone can be worsened. Also, especially, when the back plate is warped and is thereby deformed greatly, or when heat is transmitted to the back plate excessively from the circuit board side, electric charges cannot be stored in an electric layer, causing a phenomenon so called “charge loss”, resulting in that the performance of the microphone can be lowered greatly.

### SUMMARY OF THE INVENTION

The present invention aims at solving the above problems found in the conventional technology. Thus, it is an object of the invention to provide a condenser microphone which, even when the composing parts thereof are thermally distorted, not only can maintain a vibration film in a given tensed state but also can hold a condenser gap in a constant state, thereby being able to maintain the excellent sensitivity characteristic of the condenser microphone.

In attaining the above object, the invention provides a condenser microphone including: a casing including a sound hole; a vibration film disposed in the casing so as to face the sound hole; a back plate disposed opposed to the vibration film; a spacer disposed between the vibration film and the back plate; and a hold member including a spring member; wherein the back plate has an cuter peripheral shape that is smaller than an inner peripheral shape of the casing so as to provide a clearance between an outer peripheral surface of the back plate and an inner peripheral surface of the casing; the back plate is held by the hold member from an opposite side of the vibration film.

According to the present condenser microphone, the back plate can be held in such a manner that it can be moved, for example, can be expanded and contracted with respect to the casing. Thanks to this, when, after the composing parts are assembled together, such assembly is heated through a ref low furnace and the electronic components are mounted onto the circuit board by reflow soldering, because the back plate is individually held by the spring member, the back plate can be prevented against a warp or the like which could be otherwise produced due to thermal distortion caused by the difference of the coeeficients between the composing parts of the condenser microphone. This can avoid variations in the condenser gap between the back plate and vibration film, or a charge loss phenomenon and the like, which makes it possible to provide a condenser microphone having a good sensitivity characteristic.

Preferably, the condenser microphone further includes: an impedance conversion circuit disposed in the casing; wherein the hold member functions as a conductive path between the back plate and the impedance conversion circuit.

Thanks to this, since the hold member not only holds the back plate but also forms a conductive path between the back plate and impedance conversion circuit produced, the number of parts of the condenser microphone can be reduced and the structure thereof can be simplified.

Preferably, the hold member includes a plate spring.

Thanks to this, a large number of plate spring can be produced simultaneously by blanking, that is, the hold member can be produced efficiently.

Preferably, the hold member includes a frame portion and a leg portion projecting from an outer periphery of the frame portion; the frame portion is in contact with the back plate; and the leg portion is connected to the impedance conversion circuit.

In this invention, since the hold member is contacted with the impedance circuit only through the leg portion thereof, heat in the ref low soldering operation is hard to be transmitted to the back plate, which can protect an electret layer on the back plate against heat.

Preferably, the frame portion includes a spherical-shaped projecting portion that is in contact with the back plate.

Therefore, even when there are produced burrs in the end edge of the back plate by the blanking operation, an unstable connecting state due to the burrs between the hold plate and back plate can be avoided, thereby being able to provide good conduction with low electric resistance.

Preferably, the leg portion includes a spherical-shaped projection at a distal end thereof; and the spherical-shaped projection is connected to the impedance conversion circuit.

According to this structure, the burrs in the end edge of the back plate can be prevented from being connected to the leg portion of the hold member and the corners of the end edge of the back plate can be prevented from being connected to the impedance conversion circuit. And, when the projecting portion is formed such that it has a wide contact area and includes a plated layer, the hold member can be connected to the impedance conversion circuit through the plated layer, thereby being able to prevent the electric resistance of the connecting portion from increasing.

Preferably, the leg portion includes at least three of the leg portions.

Thanks to this, the hold member can be supported by, for example, four legs, which makes it possible to stabilize the hold member.

Preferably, the leg portions existing downwardly of the frame internally define a space in which an electronic components are placeable.

Thanks to this, a space within the casing can be used effectively and the whole of the condenser microphone can be prevented from increasing in bulk, thereby being able to contribute toward downsizing the condenser microphone.

Preferably, the back plate includes an original plate having an upper surface, a resin film bonded onto the upper surface of the original plate, and an electret layer formed on the resin film; and the back plate is formed by blanking the original plate from a side on which the resin film is bonded.

This can prevent the resin film from being peeled off by the blanking operation and thus a desired condenser function can be obtained with no problem.

Preferably, the spacer includes a metal plate.

According to this structure, the spacer is difficult to expand and contract when it is compared with a spacer made of synthetic resin, which can prevent the vibration film from being tensed or loosened excessively. Thanks to this, the condenser microphone can have a good sensitivity characteristic.

As described above, according to the invention, even when, as in a reflow soldering operation, a high temperature is applied, a condenser gap between the back plate and vibration film can be maintained constant to thereby be able to maintain the excellent sensitivity characteristic of the condenser microphone.

### BRIEF DESCRIPTION OF THE DRAWINGS

The present invention may be more readily described with reference to the accompanying drawings:

FIG. 1 is a cross section view of a condenser microphone according to an embodiment of the invention.

FIG. 2 is an exploded perspective view of the condenser microphone shown in FIG. 1.

FIG. 3 is an enlarged perspective view of a hold member shown in FIG. 2.

FIG. 4 is a perspective view of a modified structure of the hold member.

FIG. 5 is a perspective view of a further modification of the hold member.

### DETAILED DESCRIPTION OF THE PREFERRED EMBODIMENTS

### Embodiment

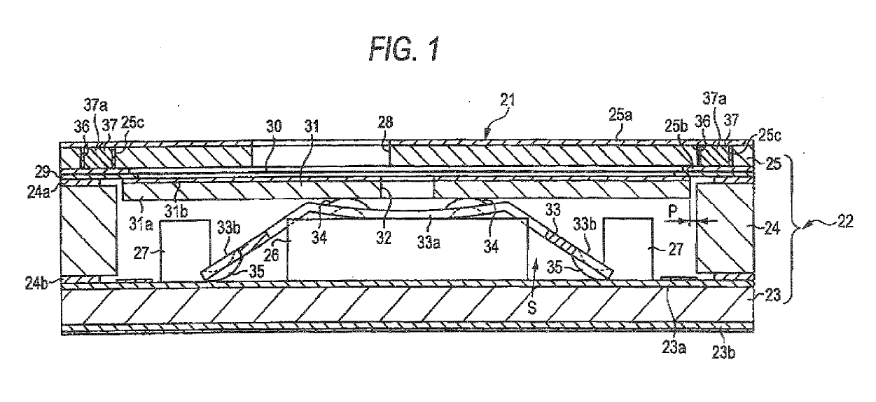

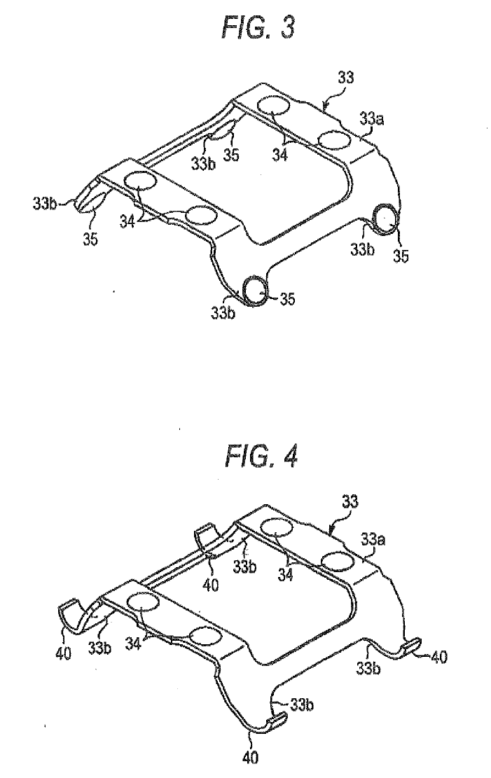

Now, description will be given below of an embodiment of a condenser microphone according to the invention with reference to FIGS. 1 to 3.

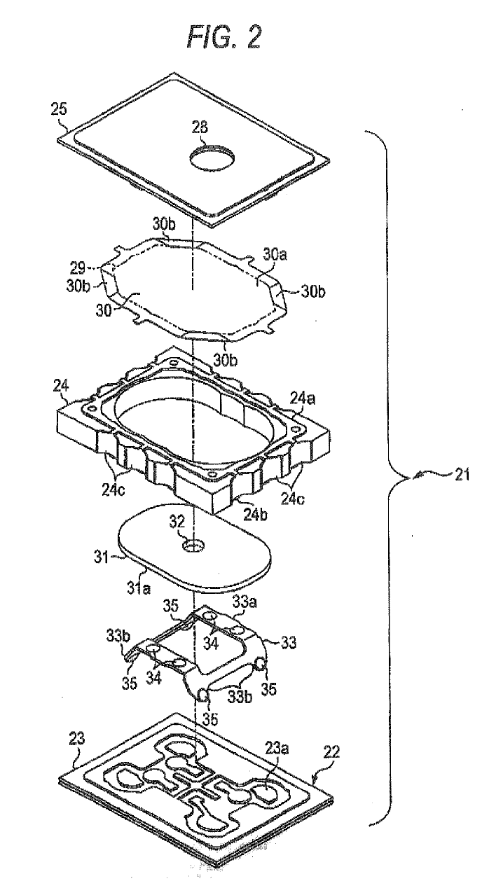

As shown in FIGS. 1 and 2, a condenser microphone 21 according to the present embodiment includes a casing 22. The casing 22 is structured such that a circuit board 23 formed in a flat plate shape, a casing base frame 24 formed in a square frame shape, a top plate 25 formed in a flat plate shape are sequentially piled up and also that these parts are fixed together with adhesive into a unified body. The circuit board 23, casing base frame 24 and top plate 25 are respectively made of electric insulation material such as epoxy resin, liquid crystal polymer, ceramic or the like. On the upper and lower surfaces of the circuit board 23, there are printed conductive patterns 23a and 23b made of copper foils or the like, respectively. And, on the circuit board 23, there are mounted electronic components such as a field-effect transistor 26 and a capacitance 27 which constitute an impedance conversion circuit fabricated within the casing 22. On the upper and lower surfaces and outer surfaces of the casing base frame 24, there are printed a conductive pattern 24a, a conductive pattern 24b, and conductive patterns 24c respectively made of a copper foil, while the conductive pattern 24b printed on the lower surface side is electrically connected to a grounding terminal (not shown) provided on the circuit board 23. And, the electronic components such as the field-effect transistor 26 and capacitor 27 respectively mounted on the circuit board 23 are respectively stored and arranged within the casing base frame 24. On the upper and lower surfaces and outer surfaces of the top substrate 25, there are printed conductive patterns 25a and 25b which are respectively made of a copper foil. In the top plate 25, there is formed a sound hole 28 which is used to take in a sound from the outside.

As shown in FIGS. 1 and 2, between the casing base frame 24 and top substrate 25, there is held and fixed a ring-shaped spacer 29 which is made of a metal plate. In the present embodiment, the spacer 29 is specifically made of a stainless steel plate. On the upper surface of the spacer 29, there is provided a vibration film 30 made of a synthetic resin thin film such as a PPS (polyphenylene sulfide) film by gluing; and, on the lower surface of the vibration film 30, there is formed a conductive layer 30a which is made by gold evaporation, within the casing base frame 24, on the lower surface of the vibration film 30, there is disposed a back plate 31 through the spacer 29 in such a manner that it is opposed to the vibration film 30 lower surface. This back plate 31 is structured such that a film 31b made of an FEP film or the like is bonded to the upper surface of its base plate 31a made of a stainless steel plate. On the film 31b, there has been enforced a polarization treatment using corona discharge or the like and, owing to the polarization treatment, the film 31b is formed as an electret layer. Therefore, since the back plate 31 constitutes a back electrode, the condenser microphone according to the present embodiment is of a back electret type.

Further, the back plate 31 is structured such that, when it is viewed in a plan view, it has a substantially elliptic shape while its outer peripheral shape is smaller than the inner peripheral shape of the casing base frame 24; and, between the outer surface of the back plate 31 and inner peripheral surface of casing base frame 24, there is formed a clearance P. In the central portion of the back plate 31, there is formed a penetration hole 32 through which, when the vibration, film 30 is vibrated, the air is allowed to move. To form this back plate 31, its original plate member made of stainless steel with the film 31b bonded thereto maybe punched using a punching blade (not shown) from the film 31b side, that is, from the upper side in FIG. 2 toward the lower side.

As shown in FIGS. 1 to 3, within the casing base frame 24, there is interposed, a hold member 33 composed of a spring member between the back plate 31 and circuit board 23 in such a manner that the hold member 33 is compressed; and, the back plate 31 is pressed due to elastic force of the hold member 33 from the opposite side of the vibration film 30 in a direction where the back plate 31 can be contacted with the lower surface of the spacer 29. This can hold a given clearance between the vibration film 30 and back plate 31, whereby there is formed a condenser part which can secure a given capacity between them.

The hold member 33 can be formed by punching its original plate member which is made of a stainless steel plate and both surfaces of which are gold plated; and, the hold member 33 includes a frame portion 33a formed in a substantially square-ring shape and four leg portions 33b respectively projecting obliquely from the four corners of the frame portion 33a to the lateral directions of the lower portion of the frame portion 33a. Therefore, between the leg portions 33b existing downwardly of the frame portion 33a, there is formed a space S. And, in the present embodiment, as shown in FIG. 1, the field-effect transistor 26 mounted on the circuit board 23 is disposed within the space S and each capacitance 27 is interposed between its associated pair of leg portions 33b. On the upper surface of the frame portion 33a of the hold member 33, there are projectingly provided four contact portions 34 which are respectively formed as spherical-shaped projections and are contacted with the lower surface of the back plate 31; and also, on the lower surfaces of the leading end portions of the four leg portions 33b, there are projectingly provided four contact portions 35 which are respectively provided in the form of spherical-shaped projections and are contacted with the partial portions of the conductive patterns formed on the circuit board 23. And, through the hold member 33, the back plate 31 is electrically connected to the impedance conversion circuit of the circuit board 23.

As shown in FIG. 1, in the top plate 25, there are formed two or more through holes 36 and, on the inner peripheral surfaces of these throughholes 36, there are provided conductive patterns 25c which are formed continuous with the conductive patterns 25a and 25b. Also, into each through hole 36, there is filled a conductive adhesive 37a, while the conductive adhesive 37a and the conductive pattern 25c cooperate together in forming a conductive portion 37. This conductive portion 37 is electrically connected to the conductive layer 30a formed on the upper surface of the vibration film 30. By the way, when the conductive pattern 25c is formed in the through hole 36, the conductive adhesive 37a may not be filled into the through hole 36. Also, when the conductive pattern 25c is not formed in the through hole 36, only the conductive adhesive 37a may be fitted into the through hole 36. When the conductive pattern 25c and conductive adhesive 37a are both arranged, the conductive property and shield property of the condenser microphone can be enhanced. Further, in the end edge of the vibration film 30, there are formed turned-up portions 30b each of which is turned up upwardly, the conductive layers 30a of the turned-up portions 30b are situated on the upper surface side of the vibration film 30, and the conductive layers 30a are connected to the conductive pattern 25b of the top plate 25. Thus, there is formed a conductive path which extends from the conductive patterns 25a and 25b as well as the conductive portion 37 of the top plate 25 through the conductive layer 30a of the vibration film 30 and the conductive patterns 24a˜24c on the casing base frame 24 to the above-mentioned grounding terminal on the circuit board 23.

Now, in the present condenser microphone 21, when a sound from a source arrives through the sound hole 28 of the top plate 25 at the vibration film 30, the vibration film 30 is vibrated according to the frequency, amplitude and waveform of the sound. And, with the vibration of the vibration film 30, a clearance between the vibration film 30 and back plate 31 is varied from the set value thereof and the impedance of the condenser is thereby varied. The variation in the condenser impedance is converted into a voltage signal by the impedance conversion circuit and the resultant voltage signal is then outputted.

The condenser microphone 21 according to the present embodiment, which operates in the above-mentioned manner, can provide the following effects.

(1) The backplate 31 not only is movably disposed within the casing base frame 24 but also is pressed against the spacer 29 by the hold member 33 from the opposite side of the vibration film 30 and is thereby pressed and held in a state where a given clearance between the back plate 31 and vibration film 30 is maintained. Therefore, in this state, the back plate 31 is allowed to expand and contract as well as move within the casing base frame 24. Thanks to this, when, after the composing parts of the condenser microphone 21 are assembled together, the assembled structure is heated through the reflow furnace and the electronic components are mounted onto the circuit board 23 by reflow soldering, the back plate 31 made of metal and the casing base frame 24 made of synthetic resin can be expanded and contracted independently of each other. This can prevent not only the clearance between the back plate 31 and vibration film 30 from varying but also the backplate 31 from being deformed. Thus, differently from the conventional structure, the variation in the condenser gap, the so called “charge loss” phenomenon and the like can be prevented, which makes it possible to prevent the condenser microphone from worsening in the sensitivity characteristic thereof.

(2) The spacer 29 with the vibration film 30 provided thereon is made of a metal plate, more specifically, a stainless steel plate. Therefore, since metal has a small coefficient of thermal expansion, the given tensed state of the vibration film 30 supported by the spacer 29 can be maintained properly, thereby being able to secure a good sensitivity characteristic.

(3) The hold member 33 is contacted with the lower surface of the back plate 31 through the four spherical-shaped contact portions 34. Therefore, even when the back plate 31 and hold member 33 has burred portions, there can be good conduction in these contact portions 34. That is, according to the conventional structure, generally, when there are produced burrs in the end edge of the hold member 33 when forming the hold member 33 by blanking, there is a possibility that such burrs can bs unstably contacted with the back plate 31; and, in such burrs, since the gold plated portion thereof is peeled off by the burrs, there is provided high electric resistance. On the other hand, according to the present embodiment of the invention, there is eliminated such fear, thereby being able to form a proper conductive path which provide low electric resistance.

(4) The hold member 33 is contacted with the electric circuit fabricated on the circuit board 23 through the spherical-shaped contact portions 35 of the four leg portions 33b. Therefore, in the above-mentioned reflow soldering operation, transmission of heat from the circuit board 23 through the hold member 33 to the back plate 31 can be reduced, thereby being able to protect the el set ret layer of the back plate 31 from heat.

(5) Similarly, the hold member 33 is contacted with the electric circuit on the circuit board 23 through the spherical-shaped contact portions 35 of the four leg portions 33b. This eliminates a fear that the end faces of the leg portions 33b having no gold plated portions and the burrs produced in the blanking operation can be contacted with the electric circuit on the circuit board 23. Thus, the electric resistance can be maintained low, which makes it possible to form a proper conductive path.

(6) Within the space S formed by the frame portions 33a and leg portions 33b of the hold member 33 and between the leg portions 33b, there can be arranged the electronic components such as the field-effect transistor 26 and capacitance 27 mounted on the circuit board 23. This can prevent the whole of the condenser microphone 21 from increasing in bulk, which can contribute toward downsizing the condenser microphone 21.

(7) The back plate 31 is formed by blanking its original plate member made of stainless steel from the upper side in FIG. 2 toward the lower side using a blanking blade (not shown) which is disposed on the film 31b side. This not only can prevent the film 31b from being peeled off from the base plate 31a of the back plate 31 but also can prevent burrs from being produced toward the vibration film 30, which makes it possible to prevent the vibration film 30 against damage.

(8) The hold member 33 is structured such that not only it can hold the backplate 31 but also can function as a conductive part interposed between the back plate 31 and the electric circuit on the circuit board. This can reduce the number of parts of the condenser microphone and also can simplify the structure thereof. Further, a large number of hold members 33 can be produced at the same time by blanking their original member, that is, the hold member 33 can be produced with high efficiency.

(9) Since the leg portions 33b are disposed in the four portions of the hold member 33, the hold member 33 can be stably supported in the four portions thereof.

(Modifications)

The present embodiment can also be enforced while it is changed into the following modifications.

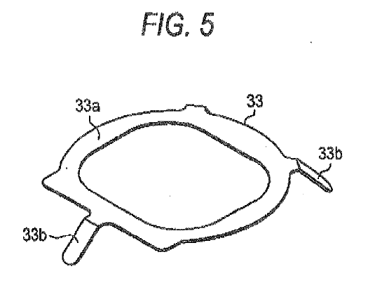

Instead of the spherical-shaped contact portions 35 that are disposed in the leading end lower portions of the four leg portions 33b of the hold member 33, as shown in FIG. 4, the leading end portions of the four leg portions 33b may also be respectively curved in an arc shape to thereby form four contact portions 40, and the hold member 33 may be connected to the electric circuit on the circuit board 23 through these contact portions 40.

As shown in FIG. 5, the number of leg portions 33b of the hold member 33 may also be reduced to three. In this structure, even when there are formed uneven height portions are formed in the electric circuit on the circuit board 23, the hold member 33 can be held stably.

Although, in the above-mentioned embodiment, the frame portion 33a of the hold member 33 is formed in a ring shape, it may also be formed in a flat plate shape.

Although, in the above-mentioned embodiment, the hold member 33 is made of a plate spring, it may also be made of a linear spring.

The spacer 29 may also be made of synthetic resin.

Although, in the above-mentioned embodiment, the present invention is embodied in the form of a condenser microphone of a back electret type, the invention may also be embodied in the form of a condenser microphone of a front electret type which includes an electret layer on the inner surface of the casing 22.

The present invention may also be embodied in the form of a condenser microphone of a foil electret type in which the vibration film 30 is made of a high polymer film for an electret.

The present invention may also be embodied in the form of a condenser microphone of a charge pump type including a booster circuit. In this structure, no electret layer exists on the back plate 31 but the vibration film 30 and back plate 31 themselves play the role of an opposed electrode; and thus, a potential difference between them is given by a charge pump or the like which is provided separately.

What is claimed is:

1. A condenser microphone comprising:
a casing including a sound hole;
a vibration film disposed in the casing so as to face the sound hole;
a back plate disposed opposed to the vibration film;
a spacer disposed between the vibration film and the back plate; and
a hold member including a spring member;
wherein the back plate has an outer peripheral shape that is smaller than an inner peripheral shape of the casing so as to provide a clearance between an outer peripheral surface of the back plate and an inner peripheral surface of the casing;
the back plate is held by the hold member from an opposite side of the vibration film.

2. The condenser microphone as claimed in claim 1, further comprising: an impedance conversion circuit disposed in the casing;
wherein the hold member functions as a conductive path between the back plate and the impedance conversion circuit.

3. The condenser microphone as claimed in claim 2,
wherein the hold member includes a plate spring.

4. The condenser microphone as claimed in claim 3,
wherein the hold member includes a frame portion and a leg portion projecting from an outer periphery of the frame portion;
the frame portion is in contact with the back plate; and
the leg portion is connected to the impedance conversion

5. The condenser microphone as claimed in claim 4,
wherein the frame portion includes a spherical-shaped projecting portion that is in contact with the back plate.

6. The condenser microphone as claimed in claim 5,
wherein the leg portion includes a spherical-shaped projection at a distal end thereof; and
the spherical-shaped projection is connected to the impedance conversion circuit.

7. The condenser microphone as claimed in claim 6,
wherein the leg portion includes at least three of the leg portions.

8. The condenser microphone as claimed in claim 7,
wherein the leg portions existing downwardly of the frame portion internally define a space in which an electronic components are placeable.

9. The condenser microphone as claimed in claim 8,
wherein the back plate includes an original plate having an upper surface, a resin film bonded onto the upper surface of the original plate, and an electret layer formed on the resin film; and
the back plate is formed by blanking the original plate from a side on which the resin film is bonded.

10. The condenser microphone as claimed in claim 9,
wherein the spacer includes a metal plate.
